(19) United States
(12) Patent Application Publication
(10) Pub. No.: US 2022/0391849 A1
(43) Pub. Date: Dec. 8, 2022

(54) GENERATING INTERVIEW QUESTIONS BASED ON SEMANTIC RELATIONSHIPS

(71) Applicant: International Business Machines Corporation, Armonk, NY (US)

(72) Inventors: James Philip O'Connor, White Plains, NY (US); Rachel Ostrand, Milford, PA (US)

(21) Appl. No.: 17/303,544

(22) Filed: Jun. 2, 2021

(51) Int. Cl. G06Q 10/10; G06F 40/30

(52) U.S. Cl. CPC G06Q 10/1053; G06F 40/30

(57) ABSTRACT

In an approach to generating interview questions, a computer retrieves a description of a job. A computer extracts one or more job requirements from the description. A computer retrieves information associated with a candidate for the job. A computer extracts an experience from the information relevant to the job. A computer identifies a first set of one or more topics associated with the one or more job requirements and a second set of one or more topics associated with the experience resulting from a first semantic search of a corpus. A computer identifies a match between at least one topic of the first set of one or more topics associated with the one or more job requirements and at least one topic of the second set of one or more topics associated with the experience. A computer generates one or more interview questions based on the match.

### BACKGROUND OF THE INVENTION

The present invention relates generally to the field of natural language processing, and more particularly to generating interview questions based on semantic relationships.

Natural language processing (NLP) is a field of computer science, artificial intelligence, and linguistics concerned with the interactions between computers and human (natural) languages. As such, natural language processing is related to the area of human—computer interaction. Many challenges in natural language processing involve natural language understanding, that is, enabling computers to derive meaning from human or natural language input.

Interviewing candidates for a job position is a costly and time consuming process for companies, especially when a large number of candidates apply for a limited number of positions, or when a company seeks to interview a large number of candidates to fill a small number of positions. Interviews typically consist of both job-specific questions and questions about a candidate's background and experience and generating such interview questions requires both technical knowledge of the position being offered as well as an understanding of the candidate's experience. While job-specific questions are likely to be the same for multiple candidates, experience-related questions are unique to each candidate. It may be difficult for an interviewer to identify the best questions to highlight the background of a specific candidate to determine whether the candidate is a good fit for the position. Existing technology extracts key qualifications and skills for a job from a job description as well as extracting key criteria from a candidate's background material to find keyword matches between the two. These keyword matches lend themselves to generating interview questions that may be the same for several candidates.

### SUMMARY

A first aspect of the present invention discloses a method including one or more computer processors retrieving a description of a job. One or more computer processors extract one or more job requirements from the description. One or more computer processors retrieve information associated with a candidate for the job. One or more computer processors extract at least one candidate experience relevant to the job from the information. One or more computer processors identify a first set of one or more topics associated with the one or more job requirements and a second set of one or more topics associated with the at least one experience resulting from a first semantic search of a corpus of text. One or more computer processors identify a match between at least one topic of the first set of one or more topics associated with the one or more job requirements and at least one topic of the second set of one or more topics associated with the at least one experience. One or more computer processors generate one or more interview questions based on the match. The present invention has the advantage of improving the quality of an interview by providing the interviewer with suggested questions to understand a candidate's relevant experience more deeply.

A second aspect of the present invention discloses a computer program product including one or more computer readable storage media and program instructions collectively stored on the one or more computer readable storage media. The stored program instructions include program instructions to retrieve a description of a job. The stored program instructions include program instructions to extract one or more job requirements from the description. The stored program instructions include program instructions to retrieve information associated with a candidate for the job. The stored program instructions include program instructions to extract at least one candidate experience relevant to the job from the information. The stored program instructions include program instructions to identify a first set of one or more topics associated with the one or more job requirements and a second set of one or more topics associated with the at least one experience resulting from a first semantic search of a corpus of text. The stored program instructions include program instructions to identify a match between at least one topic of the first set of one or more topics associated with the one or more job requirements and at least one topic of the second set of one or more topics associated with the at least one experience. The stored program instructions include program instructions to generate one or more interview questions based on the match.

A third aspect of the present invention discloses a computer system including one or more computer processors and one or more computer readable storage media, where program instructions are collectively stored on the one or more computer readable storage media. The stored program instructions include program instructions to retrieve a description of a job. The stored program instructions include program instructions to extract one or more job requirements from the description. The stored program instructions include program instructions to retrieve information associated with a candidate for the job. The stored program instructions include program instructions to extract at least one candidate experience relevant to the job from the information. The stored program instructions include program instructions to identify a first set of one or more topics associated with the one or more job requirements and a second set of one or more topics associated with the at least one experience resulting from a first semantic search of a corpus of text. The stored program instructions include program instructions to identify a match between at least one topic of the first set of one or more topics associated with the one or more job requirements and at least one topic of the second set of one or more topics associated with the at least one experience. The stored program instructions include program instructions to generate one or more interview questions based on the match.

In another aspect, the present invention discloses a method including one or more computer processors transmitting the one or more interview questions to an interviewer. One or more computer processors receive feedback associated with the one or more interview questions from the interviewer. One or more computer processors apply the one or more answers to a future semantic search. The present invention has advantage of gradually improving the database, enabling faster searches based on input from prior candidates and job descriptions.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a question generation program, on a server computer within the distributed data processing environment of FIG. 1, for generating interview questions based on semantic relationships between the job requirements and the candidate's submission materials, in accordance with an embodiment of the present invention; and

FIG. 3 depicts a block diagram of components of the server computer executing the question generation program within the distributed data processing environment of FIG. 1, in accordance with an embodiment of the present invention.

### DETAILED DESCRIPTION

Embodiments of the present invention recognize that interview efficiency may be gained by providing a system that identifies semantic relationships between topics related to the job description and topics related to a candidate's background. Embodiments of the present invention also recognize that a system that matches related topics, instead of simple keyword matching, can generate interview questions uniquely-tailored to each candidate that can explore the strengths and weaknesses of a candidate as a result of their specific experiences. Implementation of embodiments of the invention may take a variety of forms, and exemplary implementation details are discussed subsequently with reference to the Figures.

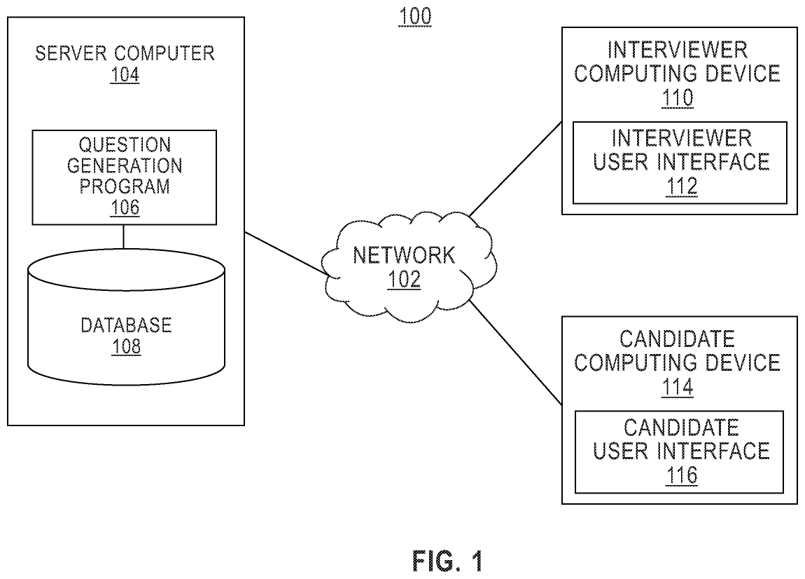

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104, interviewer computing device 110, and candidate computing device 114 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, interviewer computing device 110, candidate computing device 114, and other computing devices (not shown) within distributed data processing environment 100.

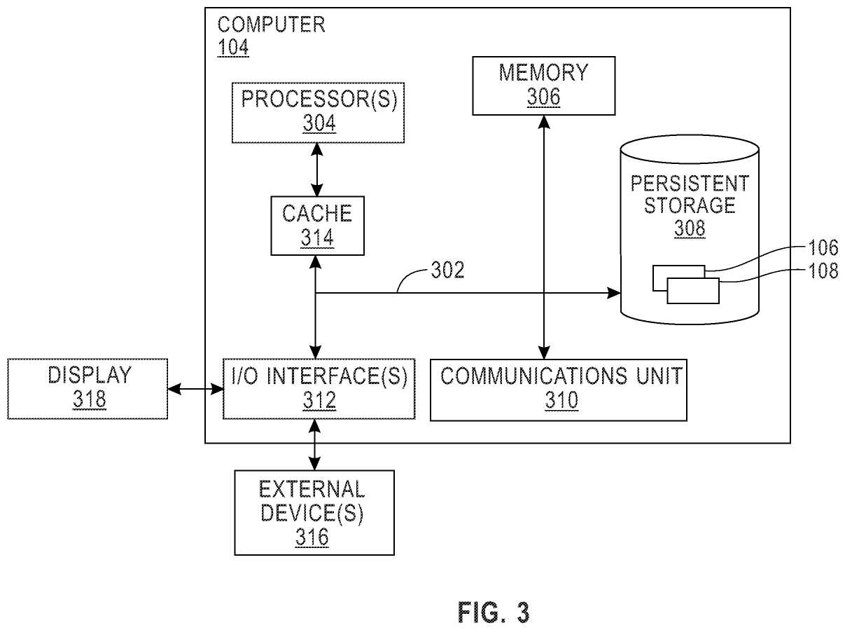

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any programmable electronic device capable of communicating with interviewer computing device 110, candidate computing device 114, and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes question generation program 106 and database 108. Server computer 104 may include internal and external hardware components, as depicted and described in further detail with respect to FIG. 3.

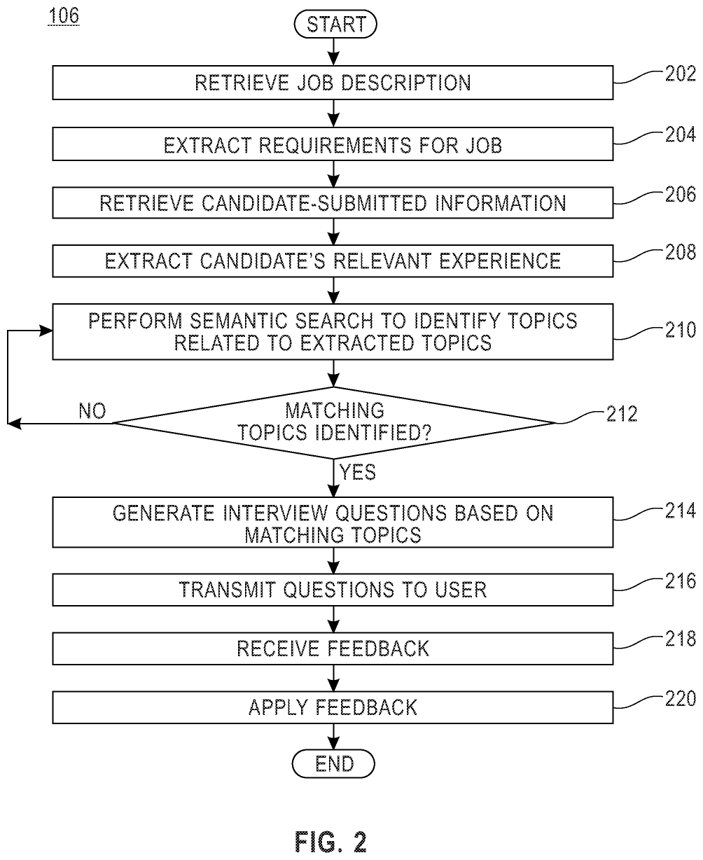

Question generation program 106 performs a semantic analysis, determining context around words and phrases, to infer meaning (e.g., levels of experience, etc.) regarding candidate competencies and required competencies. Question generation program 106 draws associations to N-order relationships between a job description and a candidate's skills and experience to form interview questions, as opposed to simply matching keywords. Question generation program 106 uses information from a job description or requisition and information from a job candidate's application materials (e.g., resume, cover letter, etc.) to generate non-obvious questions that link the candidate with specific job requirements. As used herein, “job description” can also be applied to situations that require an interview, other than jobs, such as an internship, placement in an educational institution, or recruitment for a team. Question generation program 106 retrieves a job description and extracts requirements for the job. Question generation program 106 retrieves candidate-submitted information and extracts the candidate's relevant experience. Question generation program 106 performs a semantic search to identify topics related to the extracted topics. Question generation program 106 determines whether matching topics are identified between the job-related topics and the candidate-related topics. If question generation program 106 identifies a match, then question generation program 106 generates one or more interview questions based on the matching topics. Question generation program 106 transmits the questions to a user. Question generation program 106 receives feedback from an interviewer and/or candidate as to the quality of the generated questions and applies the feedback to the question generation program to potentially improve interview questions for similar jobs and candidates in the future. Question generation program 106 is depicted and described in further detail with respect to FIG. 2.

Database 108 stores information used by and generated by question generation program 106. In the depicted embodiment, database 108 resides on server computer 104. In another embodiment, database 108 may reside elsewhere within distributed data processing environment 100, provided that question generation program 106 has access to database 108. A database is an organized collection of data. Database 108 can be implemented with any type of storage device capable of storing data and configuration files that can be accessed and utilized by question generation program 106, such as a database server, a hard disk drive, or a flash memory. Database 108 stores questions generated by question generation program 106. Database 108 may also store feedback received by question generation program 106 from an interviewer and/or a candidate. Database 108 may also store one or more interview question templates for use by question generation program 106. In an embodiment, database 108 represents one or more databases that also store one or more corpora of text. In one embodiment, the one or more corpora of text may include a large number of documents that span diverse facets of knowledge, language, and information.

In an embodiment, question generation program 106 continues to build database 108 by storing results of searches of the corpus of text for semantically related topics, such as a search for topics semantically related to a job description or candidate information. In an embodiment where database 108 stores sufficient feedback from prior job postings and candidates, and a given job is sufficiently similar to a prior job that the semantic relationships from the prior job are a good match for the current job, question generation program 106 performs a search for semantically related topics from the content of database 108. For example, two management positions may share many of the same requirements. In another example, two early career electrical engineers may have similar backgrounds and/or experiences. An advantage of the embodiment is that the content of database 108 is gradually improved such that it contains more well-targeted interview questions for a particular type of job or candidate. Another advantage of the embodiment is that the content of database 108 enables faster searches based on input from prior candidates and job descriptions, compared to a semantic searches conducted on the full corpus of text.

The present invention may contain various accessible data sources, such as database 108, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Question generation program 106 enables the authorized and secure processing of personal data. Question generation program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Question generation program 106 provides information regarding personal data and the nature (e.g., type, scope, purpose, duration, etc.) of the processing. Question generation program 106 provides the user with copies of stored personal data. Question generation program 106 allows the correction or completion of incorrect or incomplete personal data. Question generation program 106 allows the immediate deletion of personal data.

Interviewer computing device 110 and candidate computing device 114 can each be one or more of a laptop computer, a tablet computer, a smart phone, smart watch, a smart speaker, or any programmable electronic device capable of communicating with various components and devices within distributed data processing environment 100, via network 102. Interviewer computing device 110 and candidate computing device 114 may each be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In one embodiment, the wearable computer may be in the form of a head mounted display. The head mounted display may take the form-factor of a pair of glasses. In an embodiment, the wearable computer may be in the form of a smart watch. In an embodiment, interviewer computing device 110 and candidate computing device 114 may each be integrated into a vehicle of the user. For example, interviewer computing device 110 and candidate computing device 114 may each include a heads-up display in the windshield of the vehicle. In general, interviewer computing device 110 and candidate computing device 114 each represents one or more programmable electronic devices or combination of programmable electronic devices capable of executing machine readable program instructions and communicating with other computing devices (not shown) within distributed data processing environment 100 via a network, such as network 102. Interviewer computing device 110 includes an instance of interviewer user interface 112. Candidate computing device 114 includes an instance of candidate user interface 116.

Interviewer user interface 112 provides an interface between question generation program 106 on server computer 104 and a user of interviewer computing device 110. Candidate user interface 116 provides an interface between question generation program 106 on server computer 104 and a user of candidate computing device 114. In one embodiment, interviewer user interface 112 and/or candidate user interface 116 are mobile application software. Mobile application software, or an “app,” is a computer program designed to run on smart phones, tablet computers and other mobile devices. In one embodiment, interviewer user interface 112 and/or candidate user interface 116 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program.

Interviewer user interface 112 enables a user of interviewer computing device 110 to provide input regarding interviews and the generation of interview questions. For example, a user of interviewer computing device 110 can input a job description via interviewer user interface 112. Interviewer user interface 112 also enables a user of interviewer computing device 110 to provide feedback with regards to questions generated by question generation program 106 and results of interviews. Interviewer user interface 112 may also enable a user of interviewer computing device 110 to provide one or more interview question templates.

Candidate user interface 116 enables a user of candidate computing device 114 to input or upload background information and application materials, such as a resume, cover letter, curriculum vitae (CV), transcripts, etc., for storage in database 108 and/or for usage by question generation program 106. Candidate user interface 116 may also enable a user of candidate computing device 114 to provide feedback on the interview and associated questions. In one embodiment, candidate user interface 116 enables a user of candidate computing device 114 to answer interview questions generated by question generation program 106.

FIG. 2 is a flowchart depicting operational steps of question generation program 106, on server computer 104 within distributed data processing environment 100 of FIG. 1, for generating interview questions based on semantic relationships between the job requirements and the candidate's submission materials, in accordance with an embodiment of the present invention.

Question generation program 106 retrieves a job description (step 202). In an embodiment, question generation program 106 retrieves a job description from database 108. In an embodiment, a user of interviewer computing device 110 prompts question generation program 106 to retrieve the job description, via interviewer user interface 112. In an embodiment, question generation program 106 receives the job description directly from the user of interviewer computing device 110, via interviewer user interface 112. In the embodiment, question generation program 106 stores the job description in database 108.

Question generation program 106 extracts requirements for the job (step 204). In an embodiment, question generation program 106 uses one or more natural language processing (NLP) techniques, such as semantic-processing techniques, to analyze the job description and extract job requirements, such as qualifications, pre-requisites, etc. The extracted job requirements serve as semantic topics that question generation program 106 uses in a semantic search, later in the process.

Question generation program 106 retrieves candidate-submitted information (step 206). In an embodiment, question generation program 106 retrieves candidate information from database 108. In an embodiment, a user of interviewer computing device 110 prompts question generation program 106 to retrieve the candidate information, via interviewer user interface 112. In an embodiment, question generation program 106 receives the candidate information directly from the user of interviewer computing device 110, via interviewer user interface 112. In another embodiment, question generation program 106 receives the candidate information directly from the user of candidate computing device 114, via candidate user interface 116. In an embodiment, question generation program 106 stores the candidate information in database 108. Depending on the job requirements, candidate submitted information, i.e., background information and application materials, can include a resume, a cover letter, a curriculum vitae (CV), a transcript, an exam result, a certification, a skill, etc.

Question generation program 106 extracts the candidate's relevant experience (step 208). In an embodiment, question generation program 106 uses one or more NLP techniques, such as semantic-processing techniques, to analyze the candidate information and extract experience relevant to the job requirements, such as previous work experience, educational history, etc. The one or more extracted relevant experiences serve as semantic topics that question generation program 106 uses in a semantic search, later in the process.

In an embodiment, question generation program 106 performs steps 202 and 204 in parallel with steps 206 and 208.

Question generation program 106 performs a semantic search to identify topics related to the extracted topics (step 210). In an embodiment, question generation program 106 accesses one or more corpora of information in database 108 to find one or more semantic associations between terms or concepts in the extracted job requirements and related topics in a corpus. For example, if the job description is for a management position, then question generation program 106 searches a corpus for related terms/topics, and identifies topics such as “leadership,” “conflict resolution,” etc. In an embodiment, question generation program 106 accesses one or more corpora in database 108 to find one or more semantic associations between terms or concepts in the extracted relevant candidate experience and related topics in a corpus. For example, if the candidate information includes a certificate in project management, then question generation program 106 searches the corpus for related terms/topics, and identifies topics such as “organizational skills,” “time management,” etc. In an embodiment, question generation program 106 uses one or more NLP techniques to identify the related topics. For example, question generation program 106 may use the latent semantic analysis (LSA) technique to analyze relationships between a set of documents and the terms they contain to produce a set of concepts related to the documents and terms.

Question generation program 106 determines whether one or more matching topics are identified (decision block 212). In an embodiment, question generation program 106 compares the semantic topics identified for the extracted job requirements to the semantic topics identified for the extracted relevant candidate experience and determines whether any of the topics match. If question generation program 106 determines that one or more matching topics are not identified (“no” branch, decision block 212), then question generation program 106 returns to step 210 to perform an additional semantic search.

In an embodiment, whether or not a matching topic is identified between the candidate's information and a job requirement, question generation program 106 does not stop at the first semantic search for topics, but, instead, continues to perform semantic searches to identify further levels of related topics. In an embodiment, question generation program 106 continues to search for related topics, and a match between the related topics, until a minimum threshold quantity of search levels is met. In an embodiment, a user of interviewer computing device 110 provides the minimum threshold quantity of search levels, via interviewer user interface 112. For example, the user may specify that question generation program 106 continues searching and matching over a minimum of three iterations. The advantage of the embodiment is that, with a minimum threshold quantity of search levels, question generation program 106 can ignore obvious questions that result from matching the topics between the candidate's information and a job requirement that resulted from the first level search. In an embodiment, question generation program 106 continues to search for related topics, and a match between the related topics, until a maximum threshold quantity of levels is met. In an embodiment, a user of interviewer computing device 110 provides the maximum threshold quantity of search levels, via interviewer user interface 112. In the embodiment, question generation program 106 iteratively searches for a match between topics to the related candidate's information and a job requirement until either a match is found, or the maximum quantity of search levels is met. For example, the user may specify that question generation program 106 discontinues searching and matching after four iterations. If question generation program 106 finds a match after two or three iterations, then question generation program 106 discontinues searching, however if question generation program 106 fails to find a match after four iterations, then question generation program 106 discontinues searching and does not return a question. In an embodiment, question generation program 106 continues to search for related topics, and a match between the related topics, until a maximum threshold semantic distance between the topics is reached, as would be recognized by a person of skill in the art.

Continuing the previous example, question generation program 106 determines that the topic of “leadership,” that resulted from the first semantic search for related topics of the extracted job requirements, is related to the term “planning,” and question generation program 106 determines that the concept of “organizational skills,” that resulted from the first semantic search for related topics of the extracted relevant candidate experience, is related to the topic of “planning.” Thus, question generation program 106 determines that the second level topic of planning is included in the searches for both the job description and the candidate information and identifies the match.

An advantage of comparing topics matched in a second, or further, level search instead of topics matched in a first level search is that questions generated based on topics extracted from further levels of searching are non-obvious and tailored to the experience of the candidate.

If question generation program 106 determines that one or more matches are identified (“yes” branch, decision block 212), then question generation program 106 generates interview questions based on the matching topics (step 214). In an embodiment, question generation program 106 generates one or more interview questions based on the identified matches between semantically related topics of the job description and the candidate information. Continuing the example, question generation program 106 generates a question such as “how has your planning experience from your project management certification prepared you for a leadership role as a manager?” because the term “planning” was identified in both the second level related topics of the job description and the second level related topics of the candidate information. An advantage of the embodiment is that the quality of an interview is improved by providing the interviewer with suggested questions to understand a candidate's relevant experience more deeply. Another advantage of the embodiment is that question generation program 106 does not generate questions that do not link the job description to the candidate information, i.e., questions that may be irrelevant or unrelated. In an embodiment, question generation program 106 retrieves an interview question template from database 108 and imports the generated questions into the template.

In an embodiment, question generation program 106 also generates interview questions based on candidate information from another candidate. For example, if Candidate 1 has a particular type of relevant experience, then question generation program 106 can generate a question for Candidate 2 that asks whether any of Candidate 2's prior work gave them the same experience as Candidate 1. In another embodiment, question generation program 106 also generates interview questions based on a previous interview of another candidate, i.e., the questions and/or answers from a prior interview for the same, or similar, position.

Question generation program 106 transmits the interview questions to a user (step 216). In an embodiment, question generation program 106 transmits the generated interview questions to the user of interviewer computing device 110 via interviewer user interface 112. In an embodiment, the user of interviewer computing device 110 may accept some, all, or none of the transmitted questions, depending on the user's criteria for what are particularly important aspects of the job description and/or the candidate information. In an embodiment, the user of interviewer computing device 110 may edit one or more of the generated questions to modify the language of the questions. In another embodiment, question generation program 106 transmits the generated interview questions directly to the user of candidate computing device 114 via candidate user interface 116. In an embodiment where interviewer user interface 112 and/or candidate user interface 116 are apps, question generation program 106 displays the questions in the app. In another embodiment, question generation program 106 sends an email that includes a list of questions to the user of interviewer computing device 110 and/or the user of candidate computing device 114.

Question generation program 106 receives feedback (step 218). In an embodiment, question generation program 106 receives feedback from the user of interviewer computing device 110 via interviewer user interface 112. For example, the user of interviewer computing device 110 may respond to question generation program 106 with which questions the user chose to ask the candidate based on the user's criteria for importance or relevance to the interview. In another example, the user of interviewer computing device 110 may respond to question generation program 106 with additional parameters to specify job or resume areas of interest. In yet another example, the user may respond to question generation program 106 with which questions the user chose to modify. In a further example, the user may respond to question generation program 106 with any questions the candidate was unable or unwilling to answer. In another embodiment, question generation program 106 receives feedback from the user of candidate computing device 114 via candidate user interface 116. For example, if question generation program 106 transmitted the questions directly to the user of candidate computing device 114, then the user may provide responses to the questions.

Question generation program 106 applies feedback (step 220). In an embodiment, question generation program 106 stores the received feedback in database 108. In an embodiment, question generation program 106 applies the received feedback to one or more future semantic searches, thus, using interviewer feedback to favor semantic relationships that enable question generation program 106 to generate more valuable questions. An advantage of this embodiment is that by adding received feedback associated with the generated questions to database 108, question generation program 106 continually learns which questions are used and not used, which enables question generation program 106 to generate better questions in the future.

In an example of the use question generation program 106, a candidate applies for a position in the Healthcare and Life Sciences division of a large technology company. The job requires experience in computational linguistics, statistics and data analysis, and healthcare. The candidate has a PhD in cognitive science, not computational linguistics, and experience designing and running behavioral science experiments, but not explicitly in healthcare. Question generation program 106 analyzes the semantic content of the job description as well as the resume of the candidate and aligns related, but non-matching, job requirements and candidate experience. Question generation program 106 generates a question asking what aspects of the candidate's prior behavioral speech production experiments could be applied to designing clinical protocols to elicit speech data from a clinical population. The question links the candidate's experience in behavioral science to healthcare and computational linguistics applications.

In an embodiment, question generation program 106 resides on candidate computing device 114 and enables the user of candidate computing device 114 to trigger question generation program 106, via candidate user interface 116, to generate questions for the candidate to ask of the interviewer based on the job description and candidate information. In the embodiment, question generation program 106 may generate questions that highlight the candidate's experience.

FIG. 3 depicts a block diagram of components of server computer 104 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computer 104 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., question generation program 106 and database 108, are stored in persistent storage 308 for execution and/or access by one or more of the respective processor(s) 304 of server computer 104 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of interviewer computing device 110 and candidate computing device 114. In these examples, communications unit 310 includes one or more network interface cards. Communications unit 310 may provide communications through the use of either or both physical and wireless communications links. Question generation program 106, database 108, and other programs and data used for implementation of the present invention, may be downloaded to persistent storage 308 of server computer 104 through communications unit 310.

I/O interface(s) 312 allows for input and output of data with other devices that may be connected to server computer 104. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., question generation program 106 and database 108 on server computer 104, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing descriptions of the various embodiments of the present invention have been presented for purposes of illustration and example, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
retrieving, by one or more computer processors, a description of a job;
extracting, by one or more computer processors, one or more job requirements from the description;
retrieving, by one or more computer processors, information associated with a candidate for the job;
extracting, by one or more computer processors, at least one candidate experience relevant to the job from the information;
performing, by one or more computer processors, a first semantic search of a corpus of text for a first set of one or more topics associated with the one or more job requirements;
performing, by one or more computer processors, a second semantic search of the corpus of text for a second set of one or more topics associated with the at least one candidate experience;
performing, by one or more computer processors, a semantic analysis to identify a match between at least one topic of a result of the first semantic search and at least one topic of a result of the second semantic search, wherein the semantic analysis determines context around words and phrases to infer meaning to the first set of one or more topics and to the second set of one or more topics; and
generating, by one or more computer processors, one or more interview questions based on the match.

2. The computer-implemented method of claim 1, further comprising:
transmitting, by one or more computer processors, the one or more interview questions to an interviewer;
receiving, by one or more computer processors, feedback associated with the one or more interview questions from the interviewer; and
applying, by one or more computer processors, the feedback to a future semantic search.

3. The computer-implemented method of claim 1, further comprising:
transmitting, by one or more computer processors, the one or more interview questions to the candidate;
receiving, by one or more computer processors, one or more answers to the one or more interview questions from the candidate; and
applying, by one or more computer processors, the one or more answers to a future semantic search.

4. The computer-implemented method of claim 1, wherein performing the semantic analysis to identify the match between at least one topic of a result of the first semantic search and at least one topic of a result of the second semantic search further comprises:
performing, by one or more computer processors, one or more additional semantic searches of the corpus of text until a quantity of search levels meets a minimum threshold.

5. The computer-implemented method of claim 1, wherein performing the semantic analysis to identify the match between at least one topic of a result of the first semantic search and at least one topic of a result of the second semantic search further comprises:
determining, by one or more computer processors, whether a match between the at least one topic of the first set of one or more topics associated with the one or more job requirements and the at least one topic of the second set of one or more topics associated with the at least one candidate is found; and
responsive to determining the match between the at least one topic of the first set of one or more topics associated with the one or more job requirements and the at least one topic of the second set of one or more topics associated with the at least one candidate is not found, performing, by one or more computer processors, one or more additional semantic searches of the corpus of text until a quantity of search levels meets a maximum threshold.

6. The computer-implemented method of claim 1, wherein the information associated with the candidate for the job includes at least one of: background information, one or more application materials, a resume, a cover letter, a curriculum vitae (CV), a transcript, an exam result, a certification, and a skill.

7. The computer-implemented method of claim 1, wherein the first semantic search utilizes a latent semantic analysis (LSA) technique.

8. A computer program product comprising:
one or more computer readable storage media and program instructions collectively stored on the one or more computer readable storage media, the stored program instructions comprising:
program instructions to retrieve a description of a job;
program instructions to extract one or more job requirements from the description;
program instructions to retrieve information associated with a candidate for the job;
program instructions to extract at least one candidate experience relevant to the job from the information;
program instructions to perform a first semantic search of a corpus of text for a first set of one or more topics associated with the one or more job requirements;
program instructions to perform a second semantic search of the corpus of text for a second set of one or more topics associated with the at least one candidate experience;
program instructions to perform a semantic analysis to identify a match between at least one topic of a result of the first semantic search and at least one topic of a result of the second semantic search, wherein the semantic analysis determines context around words and phrases to infer meaning to the first set of one or more topics and to the second set of one or more topics; and
program instructions to generate one or more interview questions based on the match.

9. The computer program product of claim 8, the stored program instructions further comprising:
program instructions to transmit the one or more interview questions to an interviewer;
program instructions to receive feedback associated with the one or more interview questions from the interviewer; and
program instructions to apply the feedback to a future semantic search.

10. The computer program product of claim 8, the stored program instructions further comprising:
program instructions to transmit the one or more interview questions to the candidate;
program instructions to receive one or more answers to the one or more interview questions from the candidate; and
program instructions to apply the one or more answers to a future semantic search.

11. The computer program product of claim 8, wherein the program instructions to perform the semantic analysis to identify the match between at least one topic of a result of the first semantic search and at least one topic of a result of the second semantic search comprise:
program instructions to perform one or more additional semantic searches of the corpus of text until a quantity of search levels meets a minimum threshold.

12. The computer program product of claim 8, wherein the program instructions to perform the semantic analysis to identify the match between at least one topic of a result of the first semantic search and at least one topic of a result of the second semantic search experience comprise:
program instructions to determine whether a match between the at least one topic of the first set of one or more topics associated with the one or more job requirements and the at least one topic of the second set of one or more topics associated with the at least one candidate is found; and
responsive to determining the match between the at least one topic of the first set of one or more topics associated with the one or more job requirements and the at least one topic of the second set of one or more topics associated with the at least one candidate is not found, program instructions to perform one or more additional semantic searches of the corpus of text until a quantity of search levels meets a maximum threshold is met.

13. The computer program product of claim 8, wherein the information associated with the candidate for the job includes at least one of: background information, one or more application materials, a resume, a cover letter, a curriculum vitae (CV), a transcript, an exam result, a certification, and a skill.

14. The computer program product of claim 8, wherein the first semantic search utilizes a latent semantic analysis (LSA) technique.

15. A computer system comprising:
one or more computer processors;
one or more computer readable storage media;
program instructions collectively stored on the one or more computer readable storage media for execution by at least one of the one or more computer processors, the stored program instructions comprising:
program instructions to retrieve a description of a job;
program instructions to extract one or more job requirements from the description;
program instructions to retrieve information associated with a candidate for the job;
program instructions to extract at least one candidate experience relevant to the job from the information;
program instructions to perform a first semantic search of a corpus of text for a first set of one or more topics associated with the one or more job requirements;
program instructions to perform a second semantic search of the corpus of text for a second set of one or more topics associated with the at least one candidate experience;
program instructions to perform a semantic analysis to identify a match between at least one topic of a result of the first semantic search and at least one topic of a result of the second semantic search, wherein the semantic analysis determines context around words and phrases to infer meaning to the first set of one or more topics and to the second set of one or more topics; and
program instructions to generate one or more interview questions based on the match.

16. The computer system of claim 15, the stored program instructions further comprising:
program instructions to transmit the one or more interview questions to an interviewer;
program instructions to receive feedback associated with the one or more interview questions from the interviewer; and
program instructions to apply the feedback to a future semantic search.

17. The computer system of claim 15, the stored program instructions further comprising:
program instructions to transmit the one or more interview questions to the candidate;
program instructions to receive one or more answers to the one or more interview questions from the candidate; and
program instructions to apply the one or more answers to a future semantic search.

18. The computer system of claim 15, wherein the program instructions to perform the semantic analysis to identify the match between at least one topic of a result of the first semantic search and at least one topic of a result of the second semantic search comprise:
program instructions to perform one or more additional semantic searches of the corpus of text until a quantity of search levels meets a minimum threshold.

19. The computer system of claim 15, wherein the program instructions to perform the semantic analysis to identify the match between at least one topic of a result of the first semantic search and at least one topic of a result of the second semantic search comprise:
program instructions to determine whether a match between the at least one topic of the first set of one or more topics associated with the one or more job requirements and the at least one topic of the second set of one or more topics associated with the at least one candidate is found; and
responsive to determining the match between the at least one topic of the first set of one or more topics associated with the one or more job requirements and the at least one topic of the second set of one or more topics associated with the at least one candidate is not found, program instructions to perform one or more additional semantic searches of the corpus of text until a quantity of search levels meets a maximum threshold.

20. The computer system of claim 15, wherein the information associated with the candidate for the job includes at least one of: background information, one or more application materials, a resume, a cover letter, a curriculum vitae (CV), a transcript, an exam result, a certification, and a skill.
